(19) United States
(12) Patent Application Publication
(10) Pub. No.: US 2007/0284450 A1
(43) Pub. Date: Dec. 13, 2007

(54) IMAGE HANDLING

(75) Inventor: Joakim NELSON, Lund (SE)

Correspondence Address: HARRITY SNYDER, L.L.P., 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 11/422,633

(22) Filed: Jun. 7, 2006

(51) Int. Cl. G06K 7/10

(52) U.S. Cl. 235/472.02

(57) ABSTRACT

A device may include an image capturing component to capture an image. The device may include a transceiver to receive location information that identifies a location of the device when the image was captured. The device may include a processor to associate the location information with the image.

### BACKGROUND OF THE INVENTION

1. Technical Field of the Invention

Implementations described herein relate generally to digital cameras, and more particularly to performing operations related to digital images.

2. Description of Related Art

Devices, such as mobile communication devices, may perform functions other than communication functions to make these devices more useful to consumers. For example, mobile communication devices may be configured to store and play music and/or video files and/or to record still images or video.

A consumer may find mobile communication devices with image capturing capabilities to be very useful as the consumer does not have to carry a separate camera to record images. Users may find that they take pictures with their mobile communications devices at a number of locations due to the portability of the mobile communications devices. At times, users may not remember exactly where they were when pictures were taken with a mobile communications device. Users may find it difficult to label images e.g., by typing a name into the mobile communications device, since keypads on mobile devices may not lend themselves to entering long text strings. As a result, users may have to rely on their memories to remember where pictures were taken using the mobile communications device.

### BRIEF SUMMARY OF THE INVENTION

According to one aspect, a device is provided. The device may include an image capturing component to capture an image. The device may include a transceiver to receive location information that identifies a location of the device when the image was captured. The device may include a processor to associate the location information with the image.

Additionally, the location information is received from a cellular base station or a satellite.

Additionally, the location information is derived from a GPS system.

Additionally, the location information is processed by the device to determine the location of the device.

Additionally, the processor associates the location information to the image as meta-data of the image.

Additionally, the processor produces a labeled image that includes the location information.

Additionally, the transceiver sends the labeled image to a server.

Additionally, the transceiver sends the labeled image to a destination that maintains an account on behalf of the device or a user of the device.

Additionally, the processor adds the location information to the image or links the location information to the image.

According to another aspect, a computing device is provided. The computing device may include a memory to store an image portion and a label portion of a labeled image and to store label information related to the label portion. The computing device may include an interface to receive the labeled image from a wireless device and to send the image portion, the label portion, or the label information to a display. The computing device may include a processor to process the label portion, retrieve the label information based on the label portion and provide the label information to the interface.

Additionally, the label portion is provided to the wireless device by a base station or a satellite.

Additionally, the label portion identifies a transmitter servicing the wireless device when the image portion was captured on the wireless device.

Additionally, the label information identifies a landmark, scenery, an event, a road, or a feature proximate to the transmitter.

Additionally, the label information includes a map of an area encompassing the transmitter.

Additionally, the interface receives a user input and wherein the display is configured to display the image portion, display the label information, and display the user input.

Additionally, the display further displays a window that includes the image portion, a map, a user input, the label portion, or the label information.

Additionally, the computing device operates with a weblog.

According to still another aspect, a method is provided. The method may include receiving a label identifying a cellular base station; capturing an image; associating the image with the location information; and associating the image with the location information determined based on the label.

Additionally, the method may include sending a labeled image to a destination, where the labeled image comprises the image and the location information.

Additionally, the receiving further includes receiving a base station name, a base station location, time information, date information, or a feature list.

Additionally, the capturing further includes storing the location information with the image or relating the image with the location information using a link.

Additionally, the method further includes receiving user information via a keypad, a control key, a touch sensitive display, or a microphone and relating the user information to the stored image.

According to yet another aspect, a method is provided. The method may include receiving an image and an image label from a wireless device; retrieving label information based on the label; sending the image and the label information to a display device on behalf of a user; receiving a user input via an input device; and relating the user input to the image.

Additionally, the receiving the user input further includes receiving information via a keyboard.

Additionally, the receiving the user input further includes selecting a portion of the label information based on the user input; receiving text via a keyboard; and relating the selected portion of the label information and the text to the image on behalf of the user.

### BRIEF DESCRIPTION OF THE DRAWINGS

The accompanying drawings, which are incorporated in and constitute a part of this specification, illustrate one or more embodiments of the invention and, together with the description, explain the invention. In the drawings,

FIGS. 1A and 1B are diagrams of an exemplary implementation of a mobile terminal;

FIG. 2 illustrates an exemplary functional diagram of a mobile terminal;

FIG. 3 illustrates an exemplary data structure;

FIG. 4A illustrates an exemplary technique for relating an image to information;

FIG. 4B illustrates an exemplary technique for linking information to an image;

FIG. 5 illustrates an exemplary device and user interface for performing operations related to an image;

FIGS. 6A-6C illustrate exemplary windows that can be used to display information related to images; and

FIG. 7 illustrates an exemplary process that can be used to perform image related operations.

### DETAILED DESCRIPTION OF THE INVENTION

The following detailed description of the invention refers to the accompanying drawings. The same reference numbers in different drawings may identify the same or similar elements. Also, the following detailed description does not limit the invention.

Implementations of the invention can be used to perform operations related to images. For example, a mobile terminal may be equipped with a digital camera. A user may take a digital picture (image) using the camera and may wish to associate information with the image, such as information about a location where the image was taken, information about the content of the image, etc.

Implementations may receive information from a base station, such as a base station serving the mobile terminal when the image was captured, and may relate the received information to the image. For example, the mobile terminal may receive information identifying a base station (e.g., a name of the base station). The mobile terminal may associate the base station name with images that were taken while the mobile terminal was serviced by the base station. The base station name may help the user identify where he/she was when the image was captured and/or content of the image (e.g., the name of a landmark appearing in the image).

Implementations may allow the user to send the image to a host device, such as a weblog (blog) so that the user can interact with the image via another device, such as a desktop computer. The mobile terminal may send the base station information to the blog along with the image so that the user can use the base station information to help identify the image.

Implementations may allow the user to modify the base station information, access additional information from a database based on the base station information, etc. via a keyboard on the desktop computer, as the user may find it easier to enter information about stored images via a keyboard as opposed to entering information via a keypad on the mobile communications device.

Exemplary implementations of the invention will be described in the context of a mobile communications terminal. It should be understood that a mobile communication terminal is an example of one type of device that can employ image handling techniques consistent with principles of the invention and should not be construed as limiting the types of devices, or applications, that can use image handling techniques described herein. For example, image handling techniques described herein, may be used in non-wireless devices, such as film-based cameras and/or digital cameras that can be connected to a device or network via a cable or other type of interconnect, and/or other types of devices that can include camera-like functions to capture still or moving images.

### Exemplary Mobile Terminal

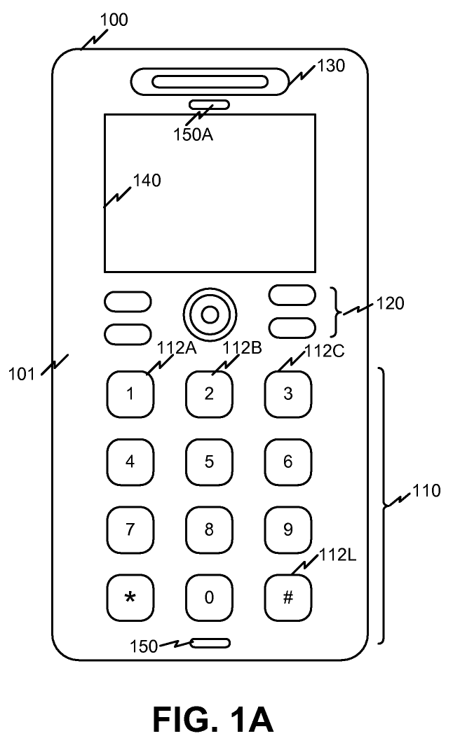

FIG. 1A is a diagram of an exemplary implementation of a mobile terminal 100 consistent with the principles of the invention. Mobile terminal 100 (hereinafter terminal 100) may be a mobile communication device. As used herein, a “mobile communication device” and/or “mobile terminal” may include a radiotelephone; a personal communications system (PCS) terminal that may combine a cellular radiotelephone with data processing, a facsimile, and data communications capabilities; a PDA that can include a radiotelephone, pager, Internet/intranet access, web browser, organizer, calendar, and/or global positioning system (GPS) receiver; and a laptop and/or palmtop receiver or other appliance that includes a radiotelephone transceiver.

Terminal 100 may include housing 101, keypad 110, control keys 120, speaker 130, display 140, and microphones 150 and 150A. Housing 101 may include a structure configured to hold devices and components used in terminal 100. For example, housing 101 may be formed from plastic, metal, or another material and may be configured to support keys 112A-L (collectively keys 112), control keys 120, speaker 130, display 140 and microphone 150 or 150A. In one implementation, housing 101 may form a front surface, or face of terminal 100.

Keypad 110 may include devices, such as keys 112A-L, that can be used to enter information into terminal 100. Keys 112 may be used in a keypad (as shown in FIG. 1A), in a keyboard, or in some other arrangement of keys. Implementations of keys 112 may have key information associated therewith, such as numbers, letters, symbols, etc. A user may interact with keys 112 to input key information into terminal 100. For example, a user may operate keys 112 to enter digits, commands, and/or text, into terminal 100.

Control keys 120 may include buttons that permit a user to interact with terminal 100 to cause terminal 100 to perform an action, such as to take a digital photograph using a digital camera embedded in terminal 100, display a text message via display 140, raise or lower a volume setting for speaker 130, etc. Speaker 130 may include a device that provides audible information to a user of terminal 100. Speaker 130 may be located in an upper portion of terminal 100 and may function as an ear piece or with an ear piece when a user is engaged in a communication session using terminal 100.

Display 140 may include a device that provides visual information to a user. For example, display 140 may provide information regarding incoming or outgoing calls, text messages, games, images, video, phone books, the current date/time, volume settings, etc., to a user of terminal 100. Display 140 may include touch-sensitive elements to allow display 140 to receive inputs from a user of terminal 100. Implementations of display 140 may display still images or video images that are received via a lens. Implementations of display 140 may further display information about devices sending information to terminal 100, such as base stations and/or other types of transmitters.

Microphones 150 and/or 150A may, respectively, include a device that converts speech or other acoustic signals into electrical signals for use by terminal 100. Microphone 150 may be located proximate to a lower side of terminal 100 and may convert spoken words or phrases into electrical signals for use by terminal 100. Microphone 150A may be located proximate to speaker 130 and may receive acoustic signals proximate to a user's ear while the user is engaged in a communications session using terminal 100. For example, microphone 150A may receive background noise and/or sound coming from speaker 130.

FIG. 1B illustrates a back surface 102 of terminal 100. Back surface 102 may include a flash 160, a lens 170, a lens cover 180, and a range finder 190. Back surface 102 may be made of plastic, metal, and/or another material and may be configured to support flash 160, lens 170, lens cover 180, and range finder 190.

Flash 160 may include a device to illuminate a subject that is being photographed with lens 170. Flash 160 may include light emitting diodes (LEDs) and/or other types of illumination devices. Lens 170 may include a device to receive optical information related to an image. For example, lens 170 may receive optical reflections from a subject and may capture a digital representation of the subject using the reflections. Lens 170 may include optical elements, mechanical elements, and/or electrical elements that operate as part of a digital camera implemented in terminal 100.

Lens cover 180 may include a device to protect lens 170 when lens 170 is not in use. Implementations of lens cover 180 may be slideably, pivotally, and/or rotationally attached to back surface 102 so that lens cover 180 can be displaced over lens 170.

Range finder 190 may include a device to determine a range from lens 170 to a subject (e.g., a subject being photographed with terminal 100). Range finder 190 may be connected to an auto-focus element in lens 170 to bring a subject into focus with respect to image capturing devices operating with lens 170. Range finder 190 may operate using ultrasonic signals, infrared signals, etc. consistent with principles of the invention.

### Exemplary Functional Diagram

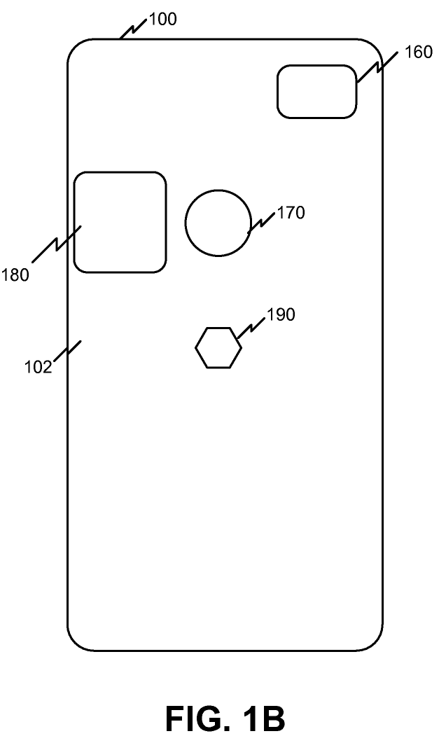

FIG. 2 illustrates an exemplary functional diagram of terminal 100 consistent with principles of the invention. As shown in FIG. 2, terminal 100 may include processing logic 210, storage 220, a user interface 230, a communication interface 240, a camera 250, base station (BS) logic 260, global positioning system (GPS) logic 270, and upload logic 280. Processing logic 210 may include a processor, microprocessor, an application specific integrated circuit (ASIC), field programmable gate array (FPGA), or the like. Processing logic 210 may include data structures or software programs to control operation of terminal 100 and its components, such as camera 250. Storage 220 may include a random access memory (RAM), a read only memory (ROM), a magnetic or optical disk and its corresponding drive and/or another type of memory to store data and instructions that may be used by processing logic 210.

User interface 230 may include mechanisms for inputting information to terminal 100 and/or for outputting information from terminal 100. Examples of input and output mechanisms might include a speaker (e.g., speaker 130) to receive electrical signals and output audio signals, a microphone (e.g., microphone 150 or 150A) to receive audio signals and output electrical signals, buttons (e.g., control keys 120 and/or keys 112) to permit data and control commands to be input into terminal 100, a display (e.g., display 140) to output visual information, and/or a vibrator to cause terminal 100 to vibrate.

Communication interface 240 may include, for example, an antenna, a transmitter that may convert baseband signals from processing logic 210 to radio frequency (RF) signals and/or a receiver that may convert RF signals from the antenna to baseband signals. Alternatively, communication interface 240 may include a transceiver that performs the functions of both a transmitter and a receiver.

Camera 250 may include hardware and software based logic to create still or moving images using terminal 100. In one implementation, camera 250 may include solid-state image capturing components, such as charge coupled devices (CCDs). In other implementations, camera 250 may include non-solid state devices, such as devices used to record images onto film.

Base station logic 260 may include software or hardware to receive information about a base station or other type of device transmitting information to terminal 100. In one implementation, base station logic 260 may receive information that identifies a base station (e.g., a name of the base station), a location of the base station (e.g., a street address and/or other geographical information), etc. Base station logic 260 may relate base station information with an image in terminal 100, such as by attaching base station information to an image. Base stations, as used with implementations of terminal 100, may be implemented as transmitters, receivers, or transceivers having both transmitting and receiving capabilities.

GPS logic 270 may include software or hardware to receive information that can be used to identify a location of terminal 100. Implementations of GPS logic 270 may receive information from satellites and/or ground based transmitters. Implementations of GPS logic 270 may provide latitude and/or longitude information to terminal 100. The latitude and/or longitude information may be used to identify a location where an image was taken with camera 250.

Upload logic 280 may include software or hardware to send an image and/or information related to an image to a destination. For example, upload logic may be used to send an image and/or information about the image to a destination device via communication interface 240, such as a server. Terminal 100 may upload labeled images to a destination so that a user of terminal 100 can store the images, access the images (e.g., accessing the images via a blog), and/or can perform image operations (e.g., labeling images, manipulating images, printing images, etc.). Upload logic 280 may operate with processing logic 210, storage 220, and/or communication interface 240 when uploading an image to a destination from terminal 100.

As will be described in detail below, terminal 100, consistent with principles of the invention, may perform certain operations relating to associating location information and/or annotations with an image (e.g., a digital photograph) taken via terminal 100. Terminal 100 may perform these operations in response to processing logic 210 executing software instructions of an image location identification application contained in a computer-readable medium, such as storage 220. A computer-readable medium may be defined as a physical or logical memory device and/or carrier wave.

The software instructions may be read into storage 220 from another computer-readable medium or from another device via communication interface 240. The software instructions contained in storage 220 may cause processing logic 210 to perform processes that will be described later. Alternatively, hardwired circuitry may be used in place of or in combination with software instructions to implement processes consistent with principles of the invention. Thus, implementations consistent with principles of the invention are not limited to any specific combination of hardware circuitry and software.

### Exemplary Data Structure

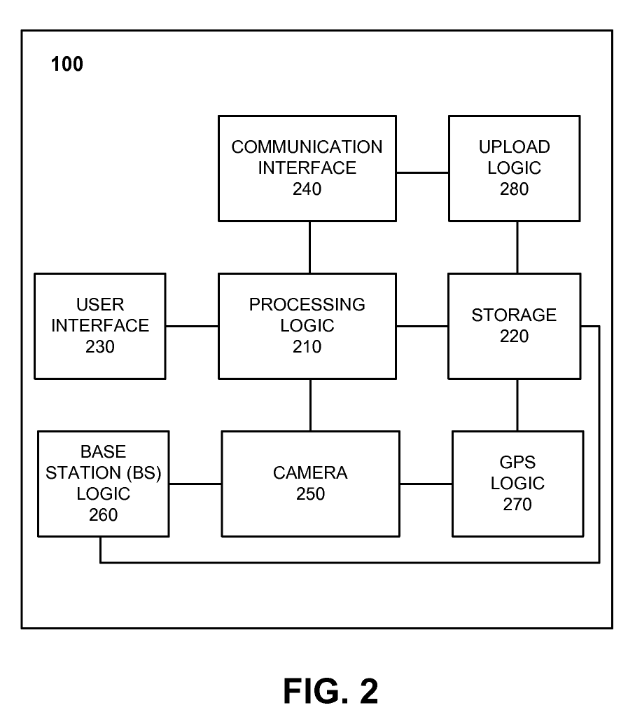

FIG. 3 illustrates an exemplary data structure consistent with principles of the invention. Data structure 300 may be implemented via a computer-readable medium that stores information in a machine-readable format. Information in data structure 300 may be arranged in a row and column format to facilitate interpretation of information in data structure 300 by a user of terminal 100 and/or processing logic 210.

Data structure 300 may include image identifier (ID) 310, date 320, time 330, location type 340, location name 350, label type 360, size 370 and status 380. Image ID 310 may include information that identifies an image in terminal 100. Image ID 310 may include a number (e.g., 01, 02, etc.), a name (image 01, first day of new job, my dog, etc.), a link (e.g., a link to a file that includes a name for the image), etc. Date 320 may include information that identifies a date related to an image identified by image ID 310. Date 320 may identify when the image was captured, modified, stored, transmitted to a destination, etc. Time 330 may include information that identifies a time at which an image identified by image ID 310 was captured, modified, stored, transmitted to a destination, etc.

Location type 340 may include information that identifies how a location of terminal 100 was determined. For example, location type 340 may include “GPS” to identify that a location of terminal 100 was determined via a signal received from a GPS satellite, “base station” to identify that a position of terminal 100 was determined using information received from a base station, etc.

Location name 350 may include information that identifies a location of terminal 100 when the image identified by image ID 310 was captured, received from another device, modified, transmitted to another device, etc. Location name 350 may include a name, a number (e.g., a street number, a latitude/longitude, etc.), and/or other type of information that can be used to identify a location. Location name 350 may be generated by components operating in terminal 100 (e.g., base station logic 260, GPS logic 270, etc.) and/or by a user of terminal 100. In other implementations, a transmitter, such as a base station or satellite, may transmit an identifier (e.g., a name of the base station or satellite) to terminal 100. Terminal 100 may write the received identifier into location name 350.

Label type 360 may include information that identifies a type of label that is related to an image identified by image ID 310. For example, a user may take a digital image via camera 250. The user may speak into microphone 150 and may record a label for the image. Alternatively, a label may include text, numbers, links, etc. The recorded label may be stored in storage 220 on terminal 100. Size 370 may include information that identifies a size of an image identified by image ID 310. Status 380 may include information that can be used to determine a status of an image identified by image ID 310. For example, status 380 may indicate that an image is being recorded, received from another device, transmitted to another device, etc.

Other implementations of data structure 300 may include additional fields or fewer fields. Moreover, implementations of terminal 100 may include substantially any number of data structures 300, such as a first data structure related to a first image and a second data structure related to a second image. Data structure 300 may be implemented in many forms. For example, in one implementation, information in data structure 300 may be stored via meta data that is related to the content of an image.

### Exemplary Image Labeling Technique

Implementations of terminal 100 may label an image with information that can be used to identify the image (e.g., an image name), a location related to the image (e.g., where the image was captured), a size of the image, a format of the image, a status of the image, etc. Images may be labeled using a variety of techniques. For example, labels can include information entered by a user of terminal 100 and/or information received from a device, such as a base station or satellite.

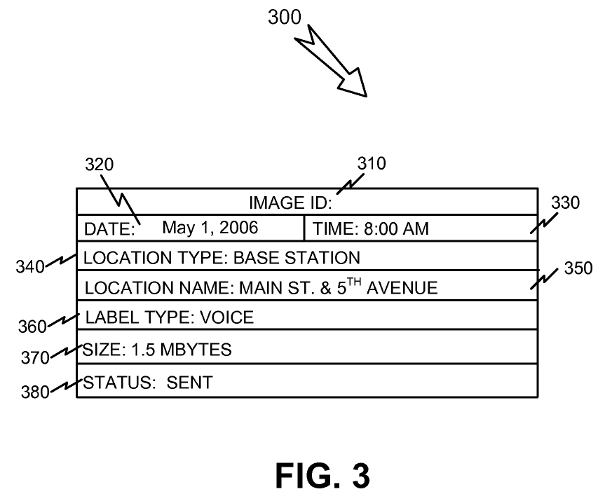

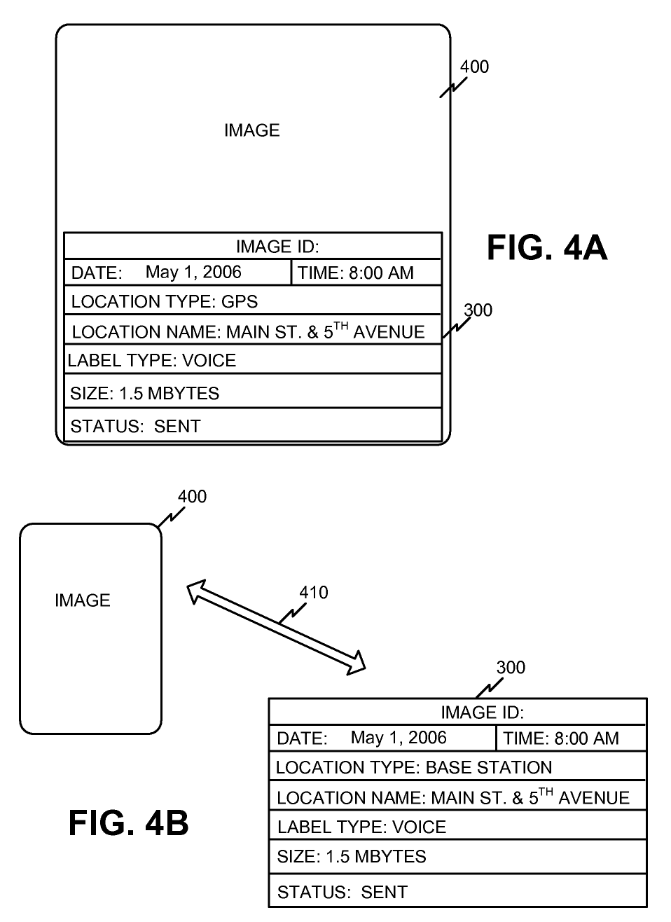

FIG. 4A illustrates an exemplary technique for relating an image to information. In FIG. 4A, an image 400 may be labeled via data structure 300 or via portions of data structure 300. Data structure 300 may be written into a portion of image 400, such as a lower portion, as shown in FIG. 4A. Data structure 300 and image 400 may be received, stored, and/or transmitted to a destination using terminal 100.

FIG. 4B illustrates an exemplary technique for linking information to an image. In the implementation of FIG. 4B, image 400 and data structure 300 may be stored separately, such as in different memory locations of storage 220, and may be linked to each other via link 410. Link 410 may include a device or technique for referencing one object with another object. In one implementation, link 410 may be a pointer.

### Exemplary User Interface

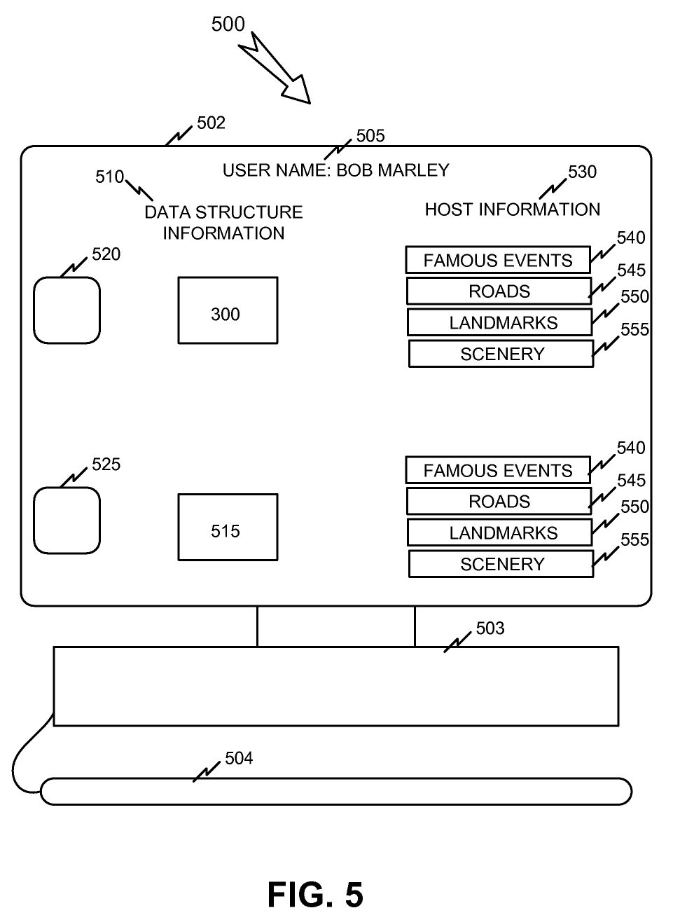

FIG. 5 illustrates an exemplary device and user interface for performing operations related to an image. A user may wish to perform image operations via a keyboard, such as a keyboard on a desk top computer, since a keyboard may make it relatively easy for the user to enter information about an image into a device, such as a computer. For example, a user may use a computer to store images, move images, add text to images, perform editing operations on images, send images to a destination, etc.

In one implementation, a user may use a computer 500 to perform image-based operations. Computer 500 may include a processing device, such as a desktop computer, a laptop computer, a client, a server, a personal digital assistant (PDA), a web-enabled cellular telephone, etc. Computer 500 may include a display 502, a processing unit 503 and a keyboard 504. Display 502 may include a device to display information to a user of computer 500. Processing unit 503 may include a device to perform processing, storage, input operations and/or output operations on behalf of computer 500. Keyboard 504 may include an input device to allow a user to input information into computer 500.

Display 502 may operate as a user interface to present image related information to a user, such as a user of terminal 100. In one implementation, display 502 may include a user name 505, data structure information 510, data structures 300 and 515, image thumbnails 520 and 525, host information 530, famous events 540, roads 545, landmarks 550 and scenery 555.

User name 505 may include information that identifies a person or device related to thumbnail images 520 and/or 525. Data structure information 510 may identify one or more data structures related to one or more images displayed in display 502. Data structure information 510 may include data structure 300 and data structure 515 and/or other data structures, such as other data structures that can be related to thumbnail images 520 and/or 525, respectively. Data structure information 510 may include all information related to a data structure or portions of information related to a data structure, such as by only including location data indicating where an image was taken.

Thumbnail image 520 or 525 may include small representations of an image, such as a scaled version of an image. Thumbnail image 520 or 525 may be sized to allow a certain number of images to be displayed on display 502 along with other information related to the images, such as data structure information 510 and/or host information 530. A user may click over thumbnail image 520 or 525 to cause a larger version of the image to be displayed on display 502.

Host information 530 may include information that can be related to an image contained in thumbnail image 520 or 525. For example, host information 530 may include information retrieved from a host database, such as a database maintained by a server operating a blog on behalf of a user of terminal 100 and/or computer 500 and/or a server related to a base station that was servicing terminal 100 when an image related to thumbnail image 520 or 525 was taken. Host information 530, may include information that can be related to an image. For example, a server may read base station information from data structure 300, such as the name of a base station (location name 350, FIG. 3) that was servicing terminal 100 when image 520 was captured. The server may process the base station name and may read information from a database that includes information that identifies events, landmarks, features, etc. that are related to the base station. The base station information may help a user identify where an image was captured when terminal 100 was serviced by the identified base station. Host information 530 may include radio buttons that cause windows to open when a user clicks over a radio button. The windows may allow the user to select information that is related to an image. In one implementation, host information may include radio buttons for famous events 540, roads 545, landmarks 550, and scenery 555.

Famous events 540 may include a radio button that is linked to information about noteworthy events that have occurred at locations serviced by a base station identified in data structure 300 and/or 515. Roads 545 may include information about roads and/or intersections that are in a coverage area for a base station identified in data structure 300 and/or 515. Landmarks 550 may include information about landmarks that are in a coverage area for a base station identified in data structure 300 and/or 515. Landmarks 550 may include information, such as names of statues, points of interest, residences of famous persons, etc. Scenery 555 may include information about scenery located within a coverage area for a base station identified in data structure 300 or 515. For example, scenery 555 may include information about natural features, such as waterfalls, rock formations, etc.

### Exemplary Windows

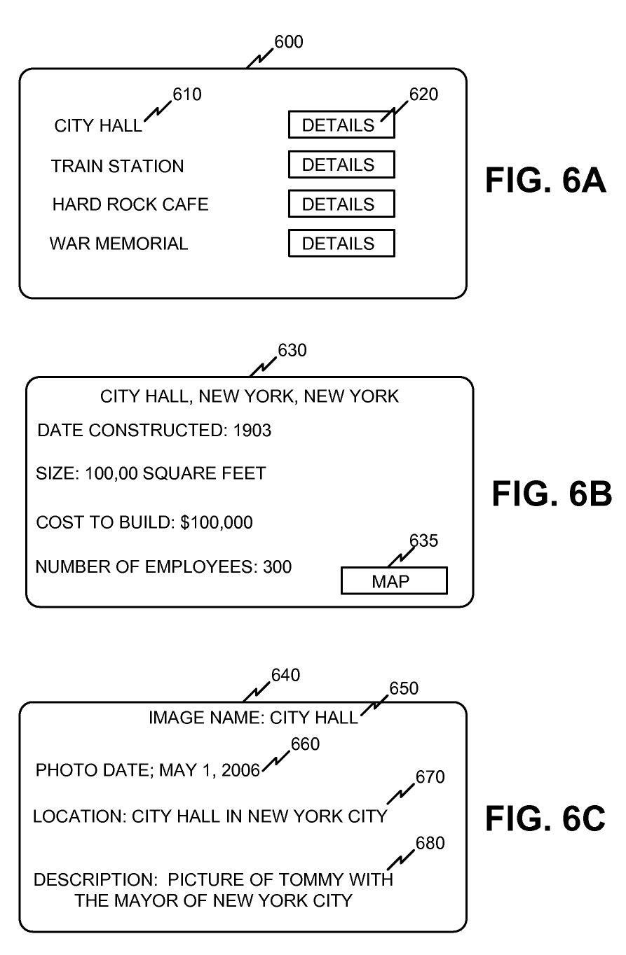

FIGS. 6A-6C illustrate exemplary windows that can be used to display information related to images. The windows of FIGS. 6A and 6B may be accessed via radio buttons, e.g., radio buttons 540-555, in display 502. In FIG. 6A, window 600 may include location identifier 610 and details 620. In one implementation, window 600 may be displayed via display 502 when a user clicks over landmarks 550 (FIG. 5).

Location identifier 610 may include information that identifies a location, such as a location name or number. Location identifier 610 may identify a location, an object at a location (e.g., a structure), and/or other features related to a location. Details 620 may include a link to information related to an item identified in location identifier 610. For example, details 620 may include a link to a window that can be used to display information about a location identified by location identifier 610.

FIG. 6B illustrates an exemplary window 630 that can be used display details about a location identified by location identifier 610. For example, a user may click on details 620 related to city hall 610 in FIG. 6A to open window 630. Window 630 may include information about city hall, such as when the building was constructed, a size of the building, and/or other information that may be of interest to a user of terminal 100 and/or display 502. Window 630 may include substantially any type of information and/or may include links to other information, such as a web site that contains additional images, text, and/or other information about city hall. For example, window 630 may include map button 635. Map button 635 may open a map window (not shown) that may include a map of areas serviced by the base station when the user clicks over map button 635. A user may select information from display 502, window 600 and/or window 630, and/or a map window and may use the selected information to label an image, such as an image related to thumbnail image 520.

FIG. 6C illustrates an exemplary window 640 that can be used by a user to enter information about an image displayed in display 502. A user may enter information into window 640 via drag and drop techniques, such as dragging an item from display 502, window 600 and/or window 630 and dropping the item into window 640, by using cut/past techniques, such as a CTRL+X sequence entered via keyboard 504, by typing information into window 640 via keyboard 504, via a microphone operating with a speech to text application on computer 500, etc.

Window 640 may include an image name 650 that may be related to location identifier 610 (FIG. 6A), thumbnail image 520, etc. Photo date 660 may include information that identifies when an image identified by image name 650 was captured. Photo date 660 may be entered by a user of display 502 or may be retrieved from data structure 300 (e.g., via date field 320, FIG. 3). Location 670 may include information related to an image identified by image name 650. Location information may be entered by a user of display 502 or may be retrieved from location name field 350 (FIG. 3). Description 680 may include information that describes an image identified by image name 650. Description 680 may include information entered by a user via keyboard 504 and/or or another type of input device. Implementations of computer 500 may also retrieve information related to description 680 from a computer-readable medium, such as a hard disk.

### Exemplary Processing

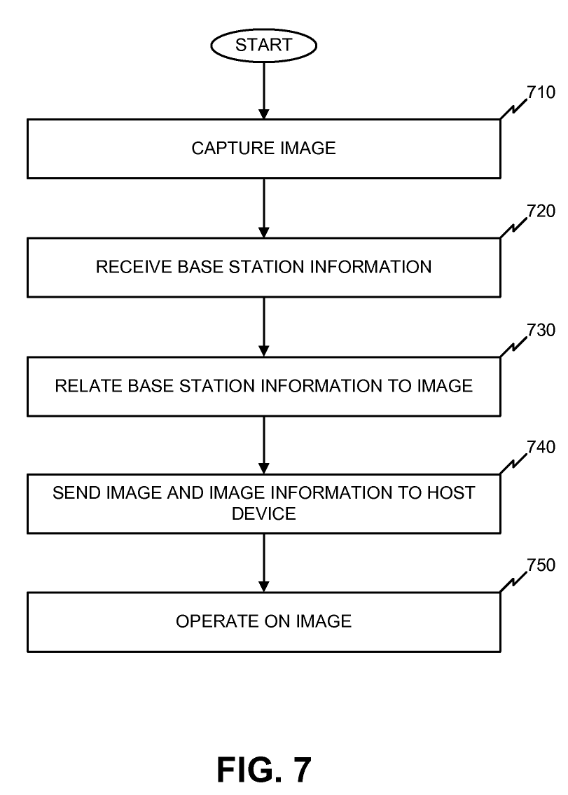

FIG. 7 illustrates an exemplary process that can be used to perform image related operations. A user may capture a digital image via terminal 100 (block 710). Assume that a user is a tourist in an unfamiliar city. For example, a Swedish citizen may be vacationing in New York City. The user may be taking in the sights of Manhattan and may be taking pictures via a cellular telephone equipped with a digital camera (e.g., terminal 100). The user may not remember the names of subjects that were photographed and/or the names of locations where pictures were taken with terminal 100 since the user is in unfamiliar surroundings.

Terminal 100 may be adapted to receive location information (block 720), such as the name of the base station that is servicing terminal 100 when terminal 100 captures an image. Implementations of terminal 100 may display base station information via display 140 and/or may store base station information via storage 220. In alternate implementations, the location information may come from other transmitting sources, such as GPS satellites. Terminal 100 may store GPS location information, such as a latitude and longitude, in storage 220. Terminal 100 may relate the location information with data in terminal 100, such as image data.

For example, terminal 100 may relate base station information with an image taken using terminal 100 (block 730). Assume the user takes a picture of St. Patrick's cathedral (hereinafter the cathedral) at the intersection of Madison Avenue and East 50^{th} Street. A base station servicing terminal 100 near the cathedral may be named “Madison.” Terminal 100 may display information about Madison on display 140 and/or may store information about Madison in storage 220. In one implementation, terminal 100 may store information received from Madison in data structure 300. In addition, terminal 100 may store other information related to the picture, such as date information, time information, an image number, etc. in data structure 300.

Terminal 100 may store data structure 300 in a portion of the cathedral image, such as in a relationship similar to the relationship illustrated in FIG. 4A, and/or may link data structure 300 to the cathedral image, such as in a relationship similar to the relationship illustrated in FIG. 4B. Information in data structure 300 may be used to identify the cathedral image stored in terminal 100. Terminal 100 may let the user add additional identifying information to the cathedral image, such as digitized speech data, alphanumeric information entered via keypad 110 and/or control keys 120, etc.

The user may decide to send the cathedral image and information related to the cathedral image to a destination. For example, the user may wish to send the cathedral image to a device that may host the cathedral image for the user and/or for other people. The user may enter an input, e.g., via control keys 120, to cause the cathedral image to be transmitted from terminal 100 to a destination.

Terminal 100 may send the image and image information to a host device in response to the user input (block 740). In one implementation, terminal 100 may send the cathedral image to the host device as a labeled image. For example, a labeled image may include image information (e.g., image data), information entered by a user of terminal 100 (e.g., a voice tag) and/or information related to the cathedral image that was received from a base station (e.g., base station location information) or other type of transmitter.

Assume that the user has an account with a server that hosts a blog. Further assume that the user wishes to send images that include the cathedral image from terminal 100 to his/her blog account on the server. The user may wish to have the cathedral image on the server so that the user can access the cathedral image using other types of devices, such as computer 500.

At some point, the user may wish to operate on the cathedral image and/or information related to the cathedral image using a computer. For example, the user may wish to interact with the cathedral image, and/or other images, via computer 500 and keyboard 504 since the computer/keyboard may make it easy for the user to annotate the image, manipulate the image, copy the image, send the image to a recipient, etc.

The user may log into his/her account on the server and may access his/her blog using computer 500. The user may scroll through images on display 502. The user may view thumbnail images, such as thumbnail images 520 and/or 525, on display 502 and may select a thumbnail image that includes the cathedral. The user may operate on the image using computer 500 (block 750). For example, the user may open a window related to the cathedral image and may enter information into the window.

Assume the user opens window 640 on display 502. Window 640 may include a name of the image, such as Saint Patrick's Cathedral. Window 640 may further include date and/or time information related to when the cathedral image was taken. Window 640 may further include information about where the cathedral is located, such as at the corner of Madison Avenue and East 50^{th} Street. The user may enter other information into window 640 via a user input device, such as keyboard 504, a microphone, etc. For example, the user may enter text describing a hymn that was playing from the bell tower of the cathedral and/or information about what the user was doing around the time that the picture was taken. The user may save information in window 640 on a server and/or other processing device related to display 502. The user may send the cathedral image and/or information about the image to a destination device, such as a friend's email account.

In another implementation, the user may have recorded the hymn played by the bell tower via microphone 150 on terminal 100. The user may have attached the digitized hymn and/or other information (e.g., information received from Madison) to the cathedral image before sending the labeled image to the server. The user may send the cathedral image, the digitized hymn, and/or other information (e.g., a text description of the cathedral image) to a destination, such as a computer operated by a relative. The relative may click on the cathedral image and may hear the hymn and may see the text description on his/her display device.

### Conclusion

Implementations consistent with principles of the invention may facilitate relating information, such as location information, to images that are captured using a mobile terminal. Implementations may further facilitate relating location information with digital images using terminal 100. Digital images, location information and/or other information, such as annotations, may be uploaded to a device, such as a server.

The foregoing description of preferred embodiments of the invention provides illustration and description, but is not intended to be exhaustive or to limit the invention to the precise form disclosed. Modifications and variations are possible in light of the above teachings or may be acquired from practice of the invention.

While a series of acts has been described with regard to FIG. 7, the order of the acts may be modified in other implementations consistent with the principles of the invention. Further, non-dependent acts may be performed in parallel.

It will be apparent to one of ordinary skill in the art that aspects of the invention, as described above, may be implemented in many different forms of software, firmware, and hardware in the implementations illustrated in the figures. The actual software code or specialized control hardware used to implement aspects consistent with the principles of the invention is not limiting of the invention. Thus, the operation and behavior of the aspects were described without reference to the specific software code—it being understood that one of ordinary skill in the art would be able to design software and control hardware to implement the aspects based on the description herein.

Further, certain portions of the invention may be implemented as “logic” that performs one or more functions. This logic may include hardware, such as hardwired logic, an application specific integrated circuit, a field programmable gate array, a microprocessor, software, or a combination of hardware and software.

It should be emphasized that the term “comprises/comprising” when used in this specification and/or claims is taken to specify the presence of stated features, integers, steps or components but does not preclude the presence or addition of one or more other features, integers, steps, components or groups thereof.

No element, act, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A device, comprising:
an image capturing component to:
capture an image;
a transceiver to:
receive location information that identifies a location of the device
when the image is captured; and
a processor to:
associate the location information with the image.

2. The device of claim 1, wherein the location information is received from a cellular base station or a satellite.

3. The device of claim 1, wherein the location information is derived from a GPS system.

4. The device of claim 1, wherein the location information is processed by the device to determine the location of the device.

5. The device of claim 1, wherein the processor produces a labeled image that includes the location information.

6. The device of claim 1, wherein the processor associates the location information with the image as meta-data of the image.

7. The device of claim 1, wherein the transceiver sends the labeled image to a server.

8. The device of claim 1, wherein the transceiver sends the labeled image to a destination that maintains an account on behalf of the device or a user of the device.

9. The device of claim 1, wherein the processor adds the location information to the image or links the location information to the image.

10. A computing device, comprising:
a memory to:
store an image portion and a label portion of a labeled image, and
store label information related to the label portion;
an interface to:
receive the labeled image from a wireless device, and
send the image portion, the label portion, or the label information to a
display; and
a processor to:
process the label portion,
retrieve the label information based on the label portion, and
provide the label information to the interface.

11. The computing device of claim 10, wherein the label portion is provided to the wireless device by a base station or a satellite.

12. The computing device of claim 11, wherein the label portion identifies a transmitter servicing the wireless device when the image portion is captured on the wireless device.

13. The computing device of claim 12, wherein the label information identifies a landmark, scenery, an event, a road, or a feature proximate to the transmitter.

14. The computing device of claim 12, wherein the label information includes a map of an area encompassing the transmitter.

15. The computing device of claim 10, wherein the interface receives a user input and wherein the display is configured to:
display the image portion,
display the label information, and
display the user input.

16. The computing device of claim 10, wherein the display further displays a window that includes the image portion, a map, a user input, the label portion, or the label information.

17. The computing device of claim 10, wherein the computing device operates with a weblog.

18. A method, comprising:
receiving a label identifying a cellular base station;
capturing an image; and
associating the image with location information determined based on the label.

19. The method of claim 18, further comprising:
sending a labeled image to a destination, where the labeled image comprises the image and the location information.

20. The method of claim 18, wherein the receiving further comprises:
receiving a base station name, a base station location, time information, date information, or a feature list.

21. The method of claim 18, wherein the capturing further comprises:
storing the location information with the image or relating the image with the location information using a link.

22. The method of claim 18, further comprising:
receiving user information via a keypad, a control key, a touch sensitive display, or a microphone; and
relating the user information to the image.

23. A method, comprising:
receiving an image and an image label from a wireless device;
retrieving label information based on the label;
sending the image and the label information to a display device on behalf of a user;
receiving a user input via an input device; and
relating the user input to the image.

24. The method of claim 23, wherein the receiving the user input further comprises:
receiving information via a keyboard;

25. The method of claim 23, wherein the receiving the user input further comprises:
selecting a portion of the label information based on the user input;
receiving text via a keyboard; and
relating the selected portion of the label information and the text to the image on behalf of the user.
